(19) United States
(12) Patent Application Publication
(10) Pub. No.: US 2011/0295884 A1
(43) Pub. Date: Dec. 1, 2011

(54) DATA CONVERSION METHOD PROCESSING FOR CONVERSION OF DATABASE, APPARATUS AND COMPUTER PROGRAM OF THE SAME

(76) Inventors: Tsuyoshi Hamamatsu, Tokyo (JP); Mitsuaki Hirayama, Tokyo (JP)

(21) Appl. No.: 13/113,325

(22) Filed: May 23, 2011

(30) Foreign Application Priority Data
May 25, 2010 (JP) 2010-119325

(51) Int. Cl. G06F 17/30

(52) U.S. Cl. 707/769; 707/E17.014

(57) ABSTRACT

The first and second table data of the SQL sentence of the query of “ACCESS” based on a predetermined conversion list is generated based on a predetermined conversion table. The data of each line of the second table data is read in the order depending on a kind of queries, and parenthesis is added to these. And the results are substituted for a variable sequentially. The value of the final variable is substituted for the third table data. And it is processed as a query after the conversion which may be processed by SQL Server.

This application claims priority under 35 U.S.C. §119 to Japanese Patent Application No. 2010-119325, filed May 25, 2010, which is incorporated in its entirety by reference.

### FIELD OF INVENTION

The present invention is related to a data conversion method processing for conversion of database, an apparatus and a program of the same

### BACKGROUND

According to change of enterprise scale etc., a predetermined database system may be converted to the other database systems. As technology for conversion of the database system, there is technology described in Japanese Unexamined Patent Application No. 2002-351710, for example.

The SQL sentences which can be used for a database system differs for every system as described in the Japanese Unexamined Patent Application. Then, in the system of the Japanese Unexamined Patent Application, smooth conversion of a database system is achieved by cooperating GUI technology and SQL sentence automatic conversion process.

Although the target for conversion in the Japanese Unexamined Patent is the SQL sentence itself, the target for conversion is not only the SQL sentence. Therefore, generally suitable conversion of the database system cannot be performed only by converting the SQL sentence.

For example, in the case that the database system to be converted is “ACCESS” (trademark) of Microsoft Corp., and the database system after conversion is similarly SQL Server of Microsoft Corp., a query name, a table name and a field name, etc. which are defined by a user using “ACCESS” have predetermined meanings in SQL Server. Therefore interpretation which is not intended is performed, and it may be in interpretation inability.

### SUMMARY OF THE INVENTION

The present invention is made for providing a data conversion method, an apparatus and a program of the same which enable convert query (an SQL sentence) of origin of conversion into an appropriate format of the destination of the conversion.

To realize some of advantages described above there is provided a data conversion method for a data conversion method for converting a first program including a plurality of first queries predetermined in a first database system into a second program including a plurality of second queries which may be processed by a second database, comprising; generating a first table data including a query type data of the first query, a table name data included in a character string of the query and a plurality of lines storing a field name data and phase name data individually; generating a second table data which converts data in the line in the first table data into expression determined in the second database system based on a predetermined conversion table; reading combination pattern data corresponded for the query classification data beforehand from a memory based on the query classification data in the second table data, reading the data in the a line of the second table data sequentially based on the order indicated in the combination pattern data; adding an indication indicating a name to be indicated by the second data base with the table name data and the field name data of the read data and storing a result of the adding to a predetermined variable; and storing the data stored in the variable a item of the post conversion query in the line corresponding to the query of the first query in the third table data used in the second database system of the second after completion of storing of data of last line of the second table data predetermined by the combination pattern data to the variable.

There is provided a data conversion apparatus for converting a first program including a plurality of first queries predetermined in a first database system into a second program including a plurality of second queries which may be processed by a second database, comprising; a first generator generating a first table data including a query type data of the first query, a table name data included in a character string of the query and a plurality of lines storing a field name data and phase name data individually; a second generator generating a second table data which converts data in the line in the first table data into expression determined in the second database system based on a predetermined conversion table; a reader reading combination pattern data corresponded for the query classification data beforehand from a memory based on the query classification data in the second table data, reading the data in the a line of the second table data sequentially based on the order indicated in the combination pattern data; an adder adding an indication indicating a name to be indicated by the second data base with the table name data and the field name data of the read data and storing a result of the adding to a predetermined variable; and a controller storing the data stored in the variable a item of the post conversion query in the line corresponding to the query of the first query in the third table data used in the second database system of the second after completion of storing of data of last line of the second table data predetermined by the combination pattern data to the variable.

There is provided a computer program tangibly embodied on a non-transitory computer readable storage medium which, when executed causes a computer to perform operation for converting a first program including a plurality of first queries predetermined in a first database system into a second program including a plurality of second queries which may be processed by a second database, the program comprises a description of processing to be executed by the computer, the processing comprises; generating a first table data including a query type data of the first query, a table name data included in a character string of the query and a plurality of lines storing a field name data and phase name data individually; generating a second table data which converts data in the line in the first table data into expression determined in the second database system based on a predetermined conversion table; reading combination pattern data corresponded for the query classification data beforehand from a memory based on the query classification data in the second table data, reading the data in the a line of the second table data sequentially based on the order indicated in the combination pattern data; adding an indication indicating a name to be indicated by the second data base with the table name data and the field name data of the read data and storing a result of the adding to a predetermined variable; and storing the data stored in the variable a item of the post conversion query in the line corresponding to the query of the first query in the third table data used in the second database system of the second after completion of storing of data of last line of the second table data predetermined by the combination pattern data to the variable.

### BRIEF DESCRIPTION OF THE DRAWINGS

FIG. 1 is a conception view of processing of data conversion apparatus relating to the embodiment of the present invention.

FIG. 2 is a functional block diagram of the data conversion apparatus relating to the embodiment of the present invention.

FIG. 3 is a flow chart to explain a summary of the processing of the data conversion apparatus shown in FIG. 2.

FIG. 4 is a flow chart to explain the processing relating to subquery of the data conversion apparatus shown in FIG. 2.

FIG. 5 is a flow chart to explain the processing of step ST22 shown in FIG. 4.

FIG. 6 is a flow chart to explain the processing of step ST22 shown in FIG. 4.

FIG. 7 is a figure to explain conversion list data to be used when data converter apparatus shown in FIG. 2 generates first table data.

FIG. 8 is a figure to explain conversion list data to be used when data converter apparatus shown in FIG. 2 generates first table data.

FIG. 9 is a figure to explain SQL sentence of the target of conversion of the present embodiment.

FIG. 10 is a figure to explain the first table data generated based on an SQL sentence shown in FIG. 9.

FIG. 11 is a figure to explain the first table data of the subquery shown in FIG. 10.

FIG. 12 is a figure to explain conversion table used by conversion of step ST2 shown in FIG. 3.

FIG. 13 is flow chart to explain step ST3 and ST4 shown in FIG. 2 in detail.

FIG. 14 is flow chart to explain step ST62 and S63 shown in FIG. 13.

FIG. 15 is a figure to explain SQL sentence after conversion shown in FIG. 9.

FIG. 16 is flow chart to explain step ST63 shown in FIG. 13.

FIG. 17 is a figure to explain third table data of the present embodiment.

FIG. 18 is a figure to explain an example of the hardware constitution of data converter apparatus shown in FIG. 2.

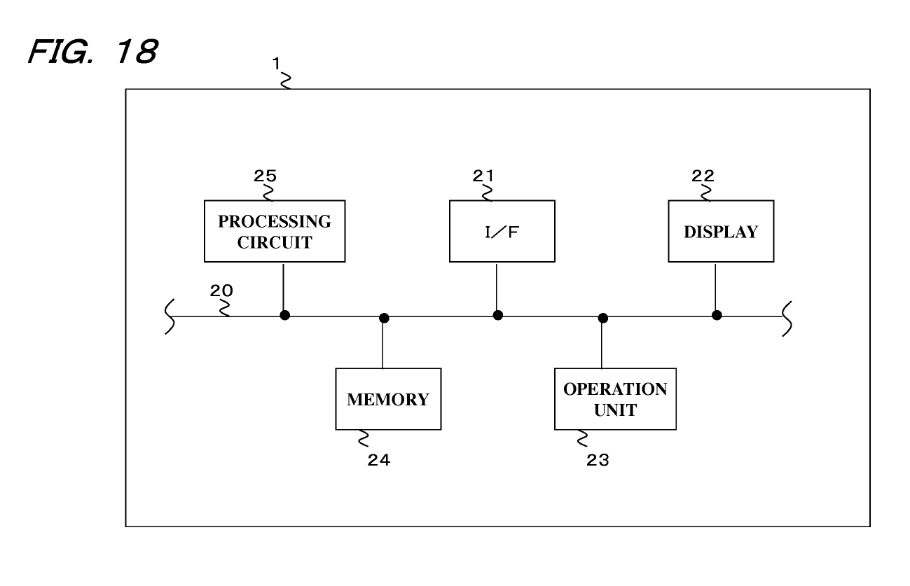

### THE PREFERRED EMBODIMENT OF THIS INVENTION

A data converter apparatus of the embodiment of the present invention will be explained as follows.

In this case an relational data base system of a target for the conversion is “ACCESS” of Microsoft Inc, and a database system of the after conversion is SQL Server of Microsoft.

In addition, the database system of the target for conversion is not limited to that.

In the relational data base system, command such as a search and an update and a deletion of data are issued using a query which is a processing request (an inquiry) for a data base management system. These queries are expressed with strings. In the search query, an extraction condition and an arrangement of a table and data for target are designated. A query which has been generated is stored and is used many times.

SQL which is language is used for a description of the query in the relational data base.

A type of the query is not defined in general-purpose data base such as “ACCESS” of Microsoft (an example of the first database system of the present invention) for programming of beginner. Therefore performance and scalability is not high.

On the other hand, in the database (an example of the second database system of the present invention) higher than SQL Server, a plurality of types are prepared, and limitation of description method, etc. are set for each query. This is for improving a performance and the scalability of the application on the database.

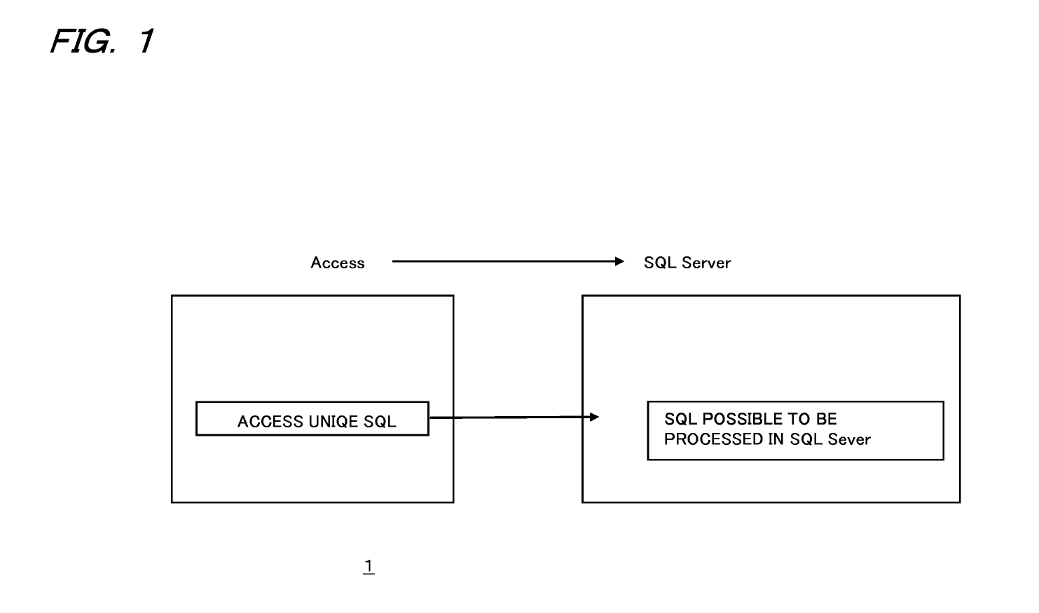

In the present embodiment, the data converter apparatus which converts a program (an SQL sentence) of “ACCESS” of Microsoft into the program which can be handled by SQL Server as shown in FIG. 1.

A specific example of the data conversion apparatus 1 of the present invention will be explained as follows.

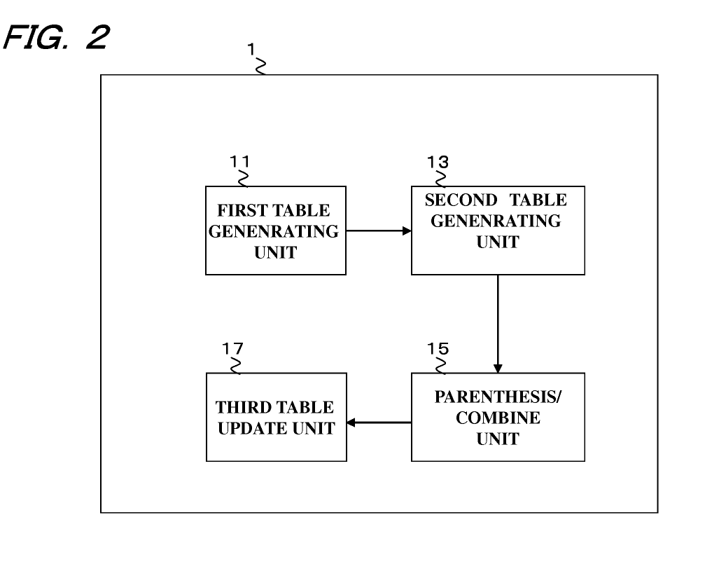

FIG. 2 is a function block diagram of the data conversion apparatus of the present embodiment of the present invention.

For example, the data conversion apparatus 1 has a first table generation unit 11, the second table generation unit 13, parenthesis-binding processing section 15 and the third table update unit 17 as shown in FIG. 2.

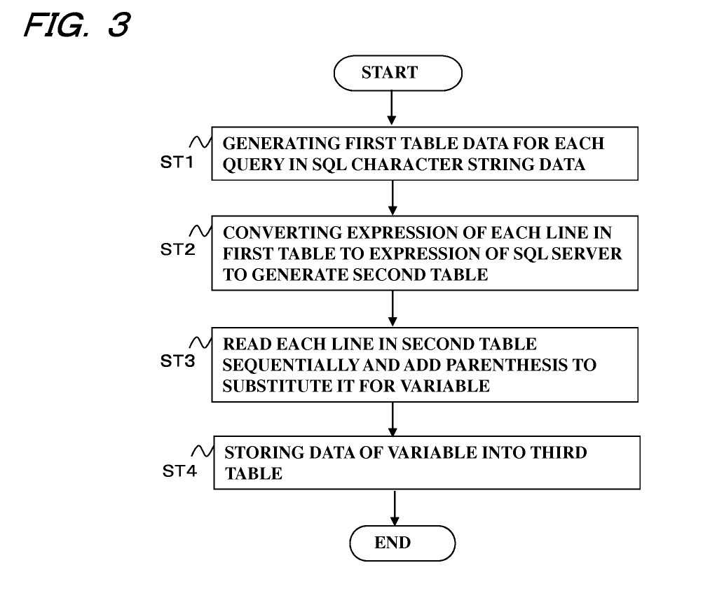

FIG. 3 is flow chart for explaining the data conversion apparatus 1 shown in FIG. 2.

Step ST1:

The first table generating unit 11 generates the first table data about each of the conversion front query which is included in a program of ACCESS of the target of the conversion. The first table data has a plurality of lines storing the query type data of the query before the conversion, table name data, field name data and phrase name data individually.

Step ST2:

The second table generating unit 13 generates the second table data which converted the name in the line in the first table data which is generated in step ST1 into expression defined in SQL Server based on a predetermined conversion list.

Step ST3:

The parenthesis/combine unit 15 reads combination pattern data corresponding to the query type data beforehand from the memory, based on the query type data in the second table data generated in step ST2.

And the parenthesis/combine unit 15 reads the data in the line of the second table data sequentially based on the order indicated by the combination pattern data which has been read.

And the parenthesis/combine unit 15 adds a parenthesis ([ ]) which is an identifier to distinguish as a name in SQL Server to the query name data, the table name data and the field name data in lines automatically, then stores these to a variable in the format defined in the second data base system.

Step ST4:

When the [17] stores the data which is shown to be stored last into the variable by the combination pattern data, the data of the variable is stored into the item of the converted query (AfterSQL) of the line corresponding to the query in the third table data.

The converted query of the third table data is the item where the query which may be processed by the SQL Server mentioned above is stored.

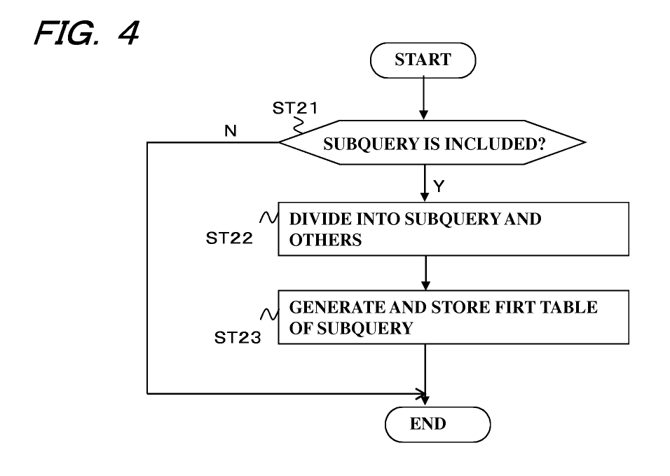

When there is a subquery in the processing of the step ST2 or step ST3 shown in FIG. 4, the data conversion apparatus 1 divides the subquery from other character string and generate the first table data for the divided subquery to stored it in the memory.

Each step shown in FIG. 4 will be explained as follows.

For example, the processing shown in FIG. 4 is carried out in a process processing each query in step ST1 shown in FIG. 3.

Step ST21:

The data conversion apparatus 1 determines whether the data in each line of the first table data include a subquery, and advances to the step ST22 when it is judged the subquery is included.

Step ST22:

The data conversion apparatus 1 divides data of line which is judged it includes the subquery at the step ST21 into the subquery and the part except the subquery. the processing concerned will be explained in detail later.

Step ST23:

The data conversion apparatus 1 generates the first table data of the subquery which is divided in step ST22.

Below the dividing processing of the subquery in step ST22 of FIG. 4 will be explained in detail.

The data conversion apparatus 1 performs the following division processing about the line where the subquery is included among the lines of the first table data.

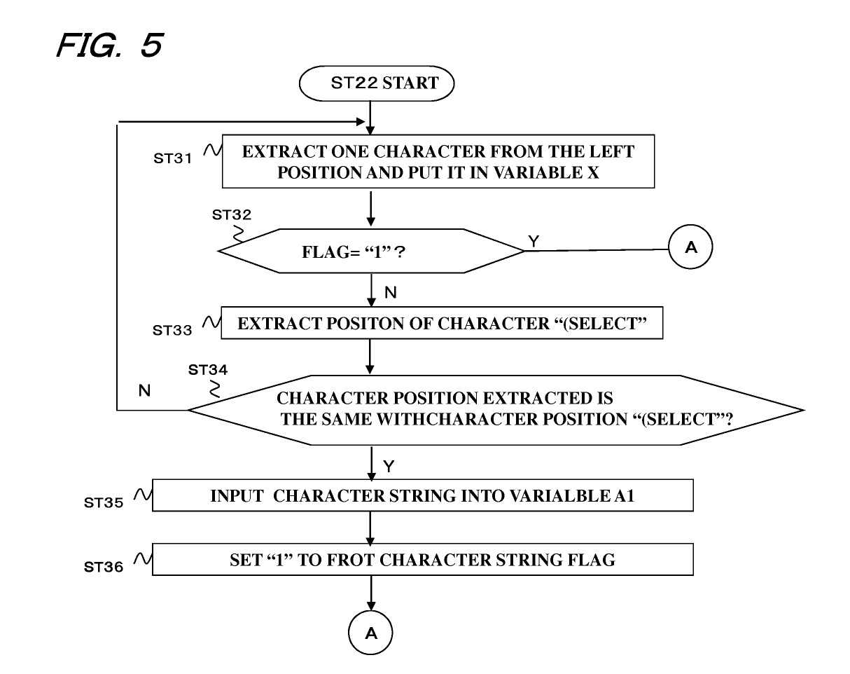

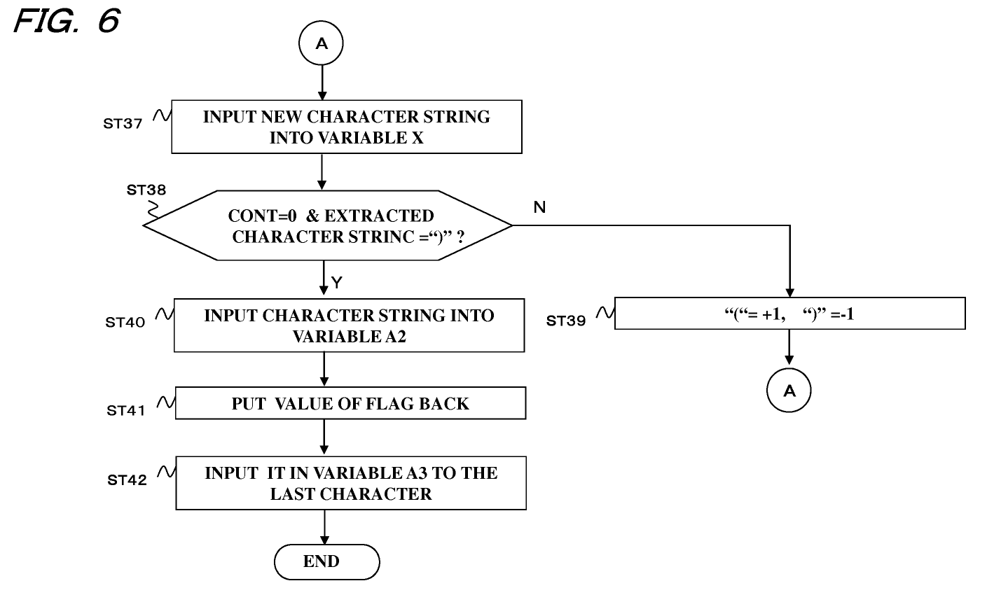

FIG. 5 and FIG. 6 are flow charts for explaining the division processing of the subquery in step ST22 of FIG. 4.

Step ST31:

The data conversion apparatus 1 extracts one character data from the data left position in the line concerned and puts it in variable X.

Step ST32:

The data conversion apparatus 1 determines whether a flag data shows “1” (it means that extraction of the previous character string has completed), and advances to step ST37 when it is judged the flag data shows “1” and advances to step ST33 when it is not so.

Step ST33:

The data conversion apparatus 1 detects (extracts) character position of “(SELEC” in a line for processing target. Step ST34:

The data conversion apparatus 1 judges whether the character position extracted at the step ST31 is the same with the character position of “(SELCT” detected at step ST33, advances to step ST35 when it is judged agree, and goes back to step ST31 when it is not so.

Step ST35:

The data conversion apparatus 1 substitutes data (previous character string data) accumulated in variable X for variable A1.

Step ST36:

The data conversion apparatus 1 sets “1” to the flag data. In addition, the data conversion apparatus 1 clears variable X.

Step ST37:

The data conversion apparatus 1 substitutes character data following the previous character string for variable [0029]

Step ST38:

The data conversion apparatus 1 judges whether a condition that counter variable C is “0” and the character extracted is “)” is satisfied. The data conversion apparatus 1 advances to step ST40 when judging the condition is satisfied, and advances to step ST39 when judging the condition is not satisfied. “0” is stored as an initial value in counter variable C.

Step ST39:

The data conversion apparatus 1 incremented the value of count C only by “1” when judged that the letter which extracted is “)”, and decrement the value of count C when judged that the letter which extracted is “(”. Then the data conversion apparatus 1 returns to step ST37.

Step ST40:

The data conversion apparatus 1 substitutes data (subquery data) accumulated in variable X for variable A2.

Step ST41:

The data conversion apparatus 1 sets “0” to the flag data. In addition, the data conversion apparatus 1 clears variable X.

Step ST42:

The data conversion apparatus 1 extracts the last letter from the next letter to the end letter in the line concerned and puts it in variable A3.

When the target letter data are as follows, variable A1, A2, A3 will be as follows.

(((employee.ID)=(SELECT employee.ID FROM employee WHERE (((employee.ID)=1)))))

Variable A1=″(((employee.ID)=(“

Variable A2=“SELECT employee.ID FROM employee WHERE (((employee.ID)=1))”

Variable A3=“)))”

The processing of each step described in FIG. 3 will be explained as follows in detail.

[Step ST1]

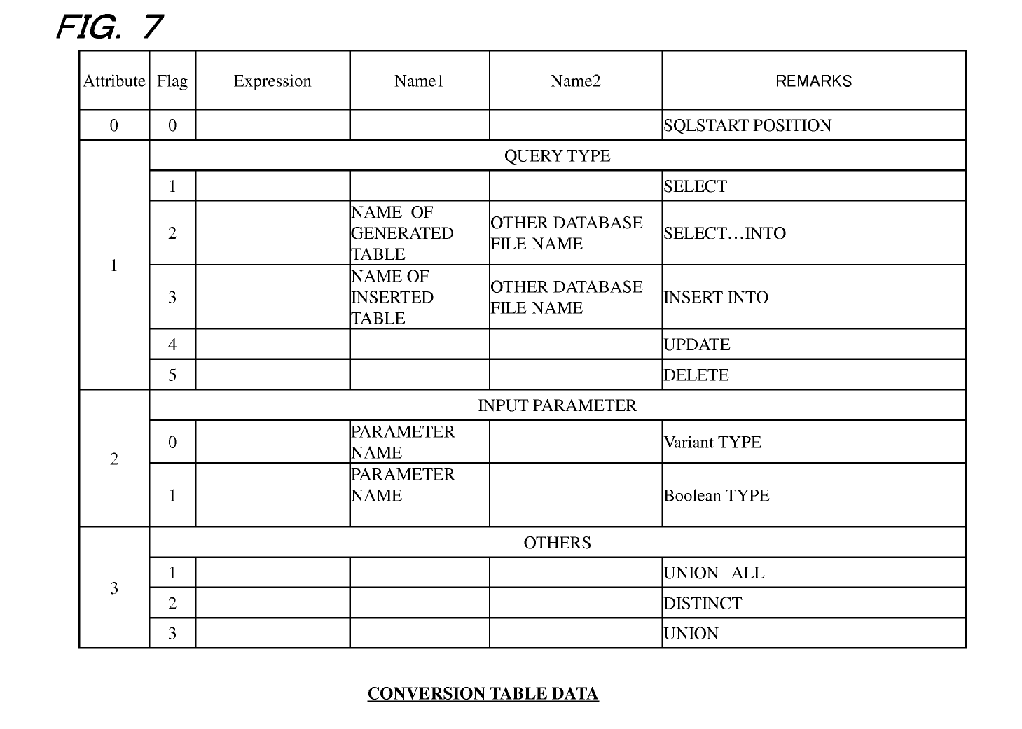

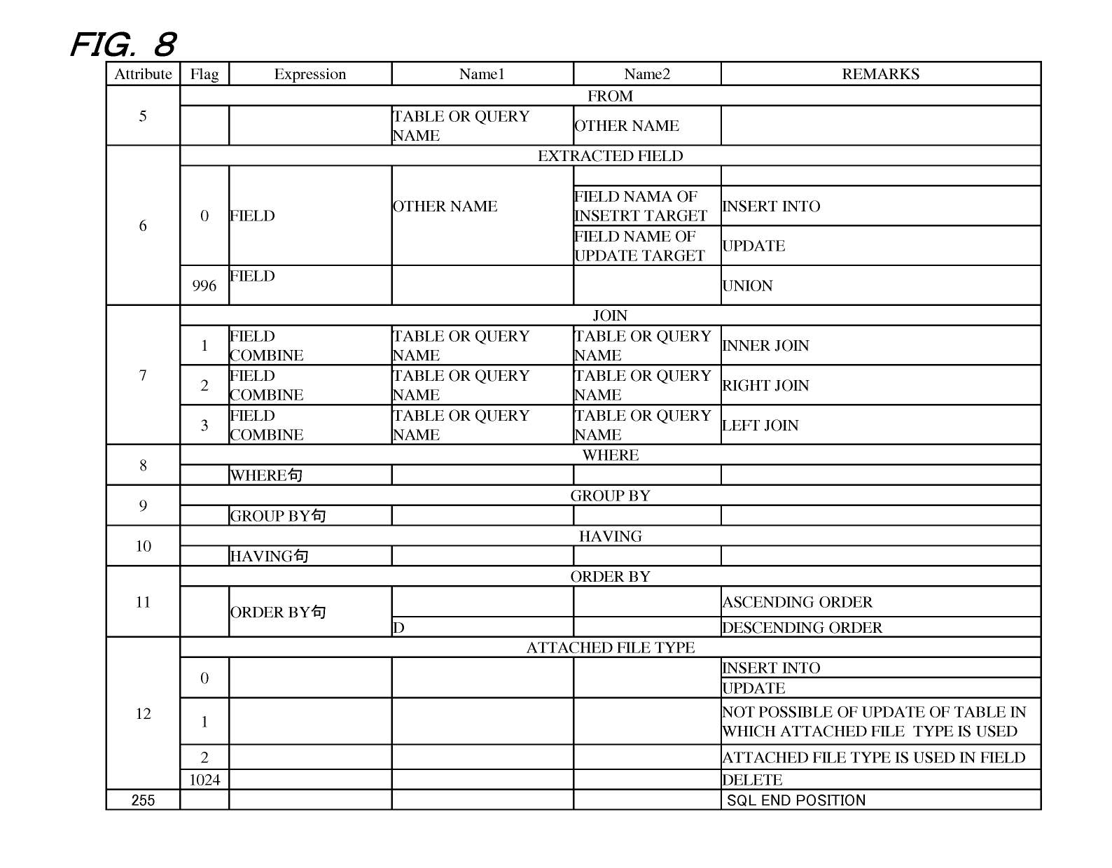

The first table generating unit 11 generates the first table data comprising plural lines storing the query classification data of the conversion front query, table name data, field name data and phrase name data for each of the conversion front query individually based on the conversion list data shown in FIG. 7 and FIG. 8 memorized in memory.

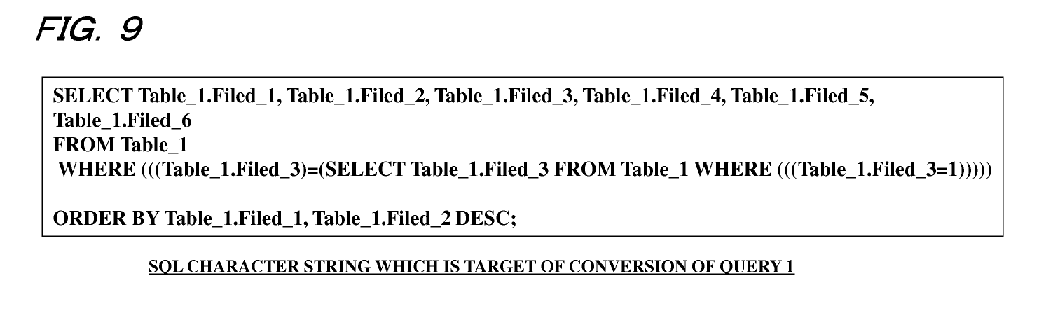

Specifically, for example, the first table generating unit 11 performs the following processes to the SQL sentence data of “ACCESS” shown in FIG. 9.

In other words, the first table generating unit 11 traces the SQL sentence data of “ACCESS” for the conversion. And the first table generating unit 11 generates a line of “(Attribute, Flag)=(0, 0)” in the second table data when detecting, for example, a query name. Then, the first table generating unit 11 adds a line of “(Attribute, Flag)=(1, 1)” because the query name is “SELECT”.

Then the first table generating unit 11 adds a line of “(Attribute, Flag)=(5,)” in the second table data for detecting a table name “Table_{—}1”. In this way, the first table generating unit 11 traces a program of ACCESS for the conversion sequentially from the top and adds a line to the second table data using attribute table data shown in FIG. 7 and FIG. 8.

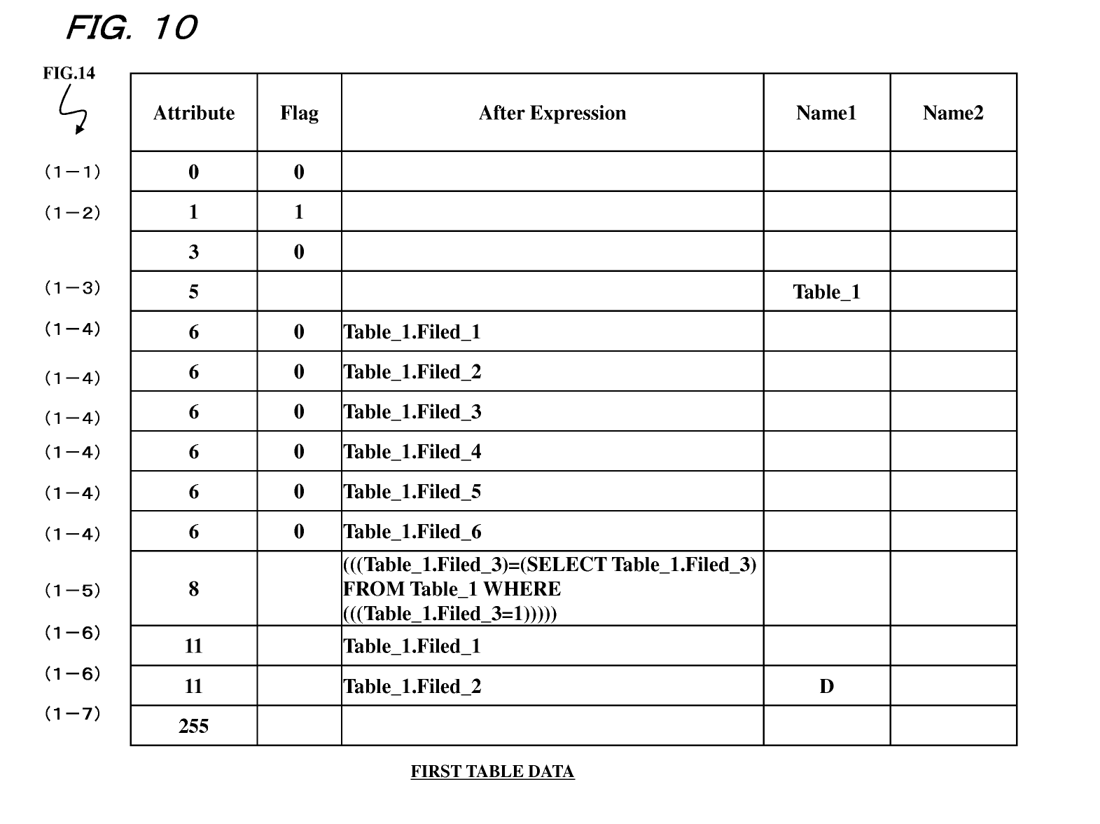

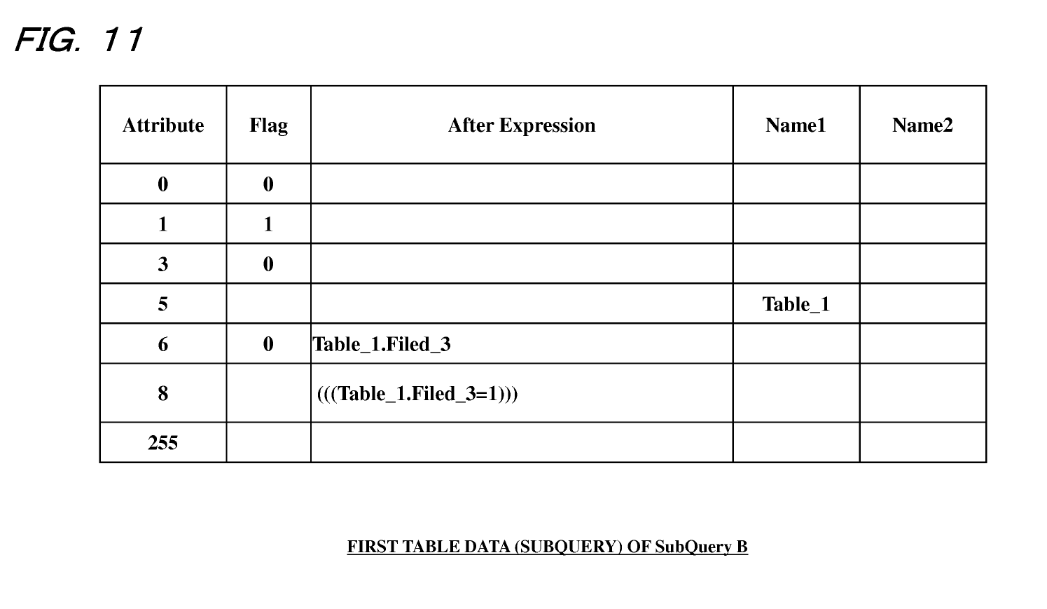

As a result the first table generating unit 11 generates the second table data shown in FIG. 10. In addition, the data conversion apparatus 1 carries out step ST22 and ST23 shown in FIG. 4 in a process generating the second table data shown in FIG. 10. And, for example, the data conversion apparatus 1 generates and stores the first table data of subquery shown in FIG. 11.

[Step ST2]

The second table generating unit 13 generates the second table data which converted the name in the a line in the first table data generated in step ST1 into expression defined in SQL Server, based on a predetermined conversion list.

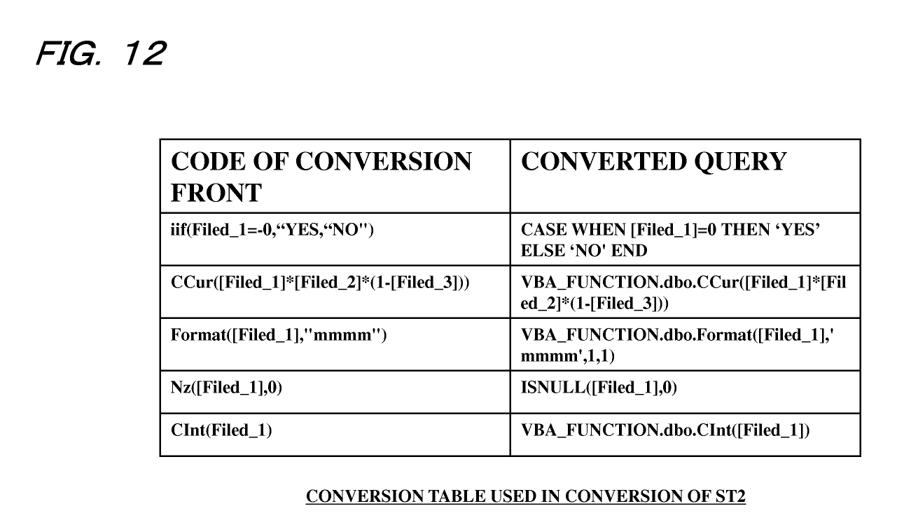

FIG. 12 is one example of the conversion list concerned.

[Step ST3]

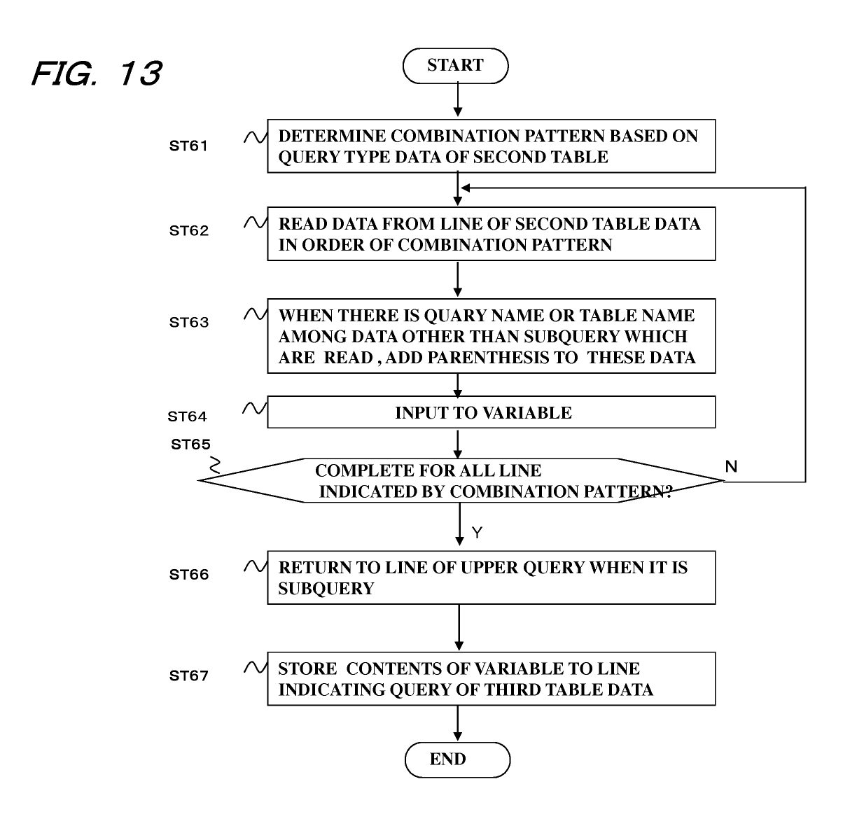

FIG. 13 is a flow chart for explaining the process of step ST3 shown in FIG. 3.

In addition, the data conversion apparatus 1 performs process shown in FIG. 13 for query from a subquery of bottom layer to a query of top layer sequentially.

Each step shown in FIG. 13 will be explained as follows in detail.

[Step ST61]

Based on the query type data in the second table data generated in step ST2 from memory, the parenthesis/combine unit 15 reads the combination pattern data corresponding to it.

The combination pattern data concerned indicates order for reading and assembling the line from the second table data of the conversion front query when generating the converted query of the query as for the conversion front query corresponding to the combination pattern data.

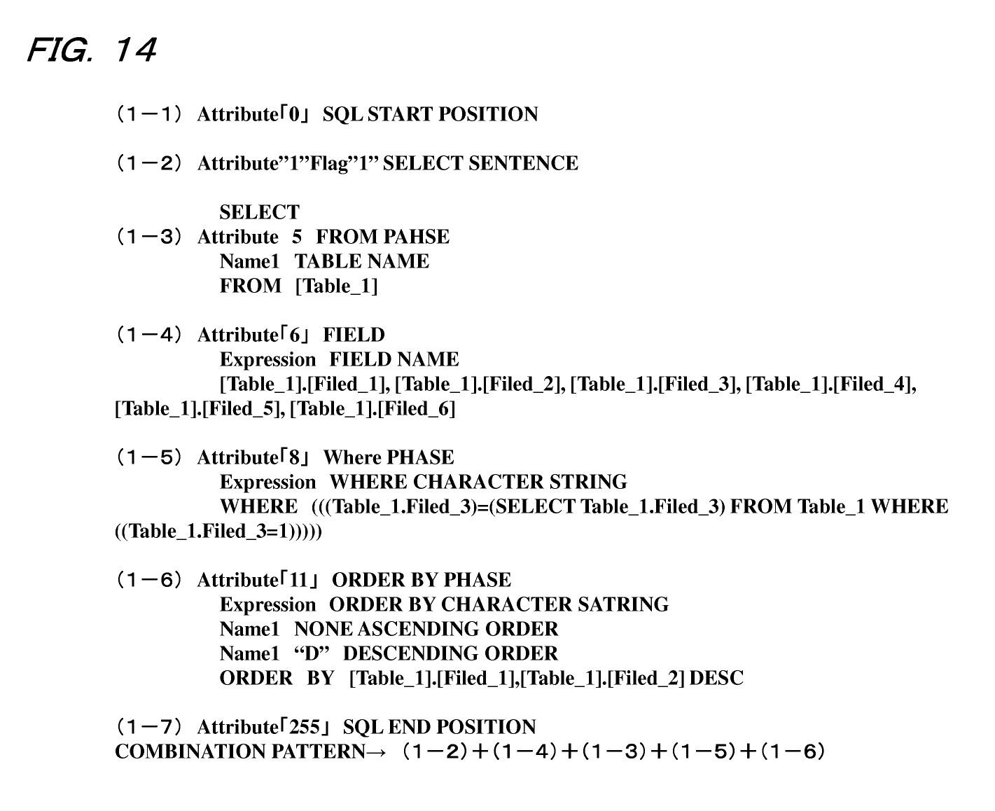

For example, each line of the second table data of “SELECT” shown in FIG. 10 is interpreted as (1-1) to (1-7) shown in FIG. 14 and read out by the data conversion apparatus 1. The combination pattern data show that they are connected in order “(1-2)+(1-4)+(1-3)+(1-5)+(1-6)”.

Step ST62:

The parenthesis/combine unit 15 reads the data of the line of the second table data by the order that the combination pattern data read in step ST61 indicates.

Step ST63:

The parenthesis/combine unit 15 performs processing of adding a parenthesis “[ ]” surrounding the query name data, table name data and the field name data in the data read in step ST62.

Step ST64:

The parenthesis/combine unit 15 substitutes the data of the line after the processing for variable Y in the order of step ST62 and step ST63. As a result, the data in which the data read from the line of the second table data are combined in the order indicated by the combination pattern data is stored in the variable Y.

Step ST65:

The parenthesis/combine unit 15 judges whether or not the processing of substituting the data of all lines indicated in the combination pattern read in step ST61 for variable Y to combine has completed. When judging the processing has completed, the parenthesis/combine unit 15 advances to step ST66, otherwise advances to step ST62.

Step ST66:

The parenthesis/combine unit 15 performs process of returning data (combination character string data) which is substituted for the variable Y for the subquery into the corresponding line of the upper query (or subquery) when a target of the process is a subquery.

Step ST67:

The parenthesis/combine unit 15 stores data (combination character string data) substituted for variable Y about a query in the item of “AfterSQL” of the query in the third table data concerned when the target of the processing is a query and the converted data of all subqueries of the inside has been returned.

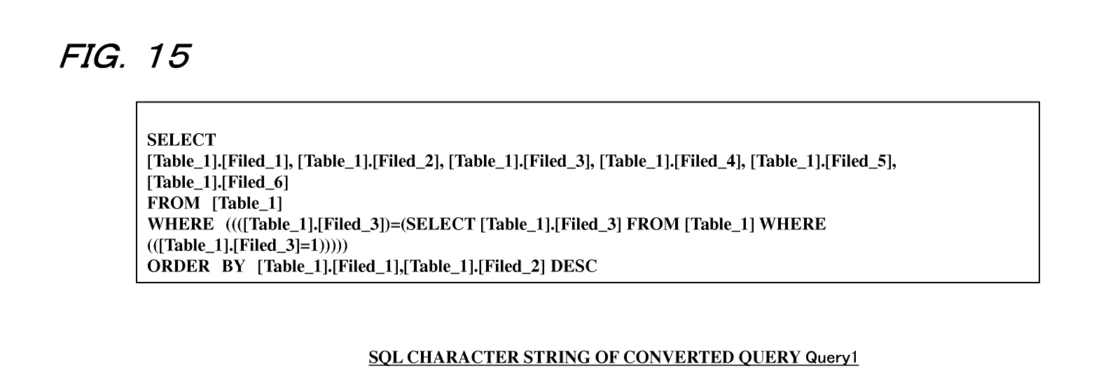

The conversion front query shown in FIG. 9 is converted into a converted query shown in FIG. 15 by the processing described above.

For example, the processing about (1-4) shown in FIG. 10 is carried out in the following procedures.

Variable Y=SELECT:

Processing of binding “[Table_{—}1.Field_{—}1]” to generate “[Table_{—}1]. [Field_{—}1]”

Variable Y=SELECT [Table_{—}1].[Field_{—}1]:

Processing of binding “[Table_{—}1.Field_{—}2]” to generate “[Table_{—}1].[Field_{—}2]”.

Variable Y=SELECT [Table_{—}1].[Field_{—}1], [Table_{—}1].[Field_{—}2]

Processing of binding “Table_{—}1.Field_{—}3” to generate “[Table_{—}1].[Field_{—}3]”:

Variable Y=SELECT [Table_{—}1].[Field_{—}1], [Table_{—}1].[Field_{—}2], [Table_{—}1].[Field_{—}3]]

Processing of step ST63 shown in FIG. 13 will be explained as follows.

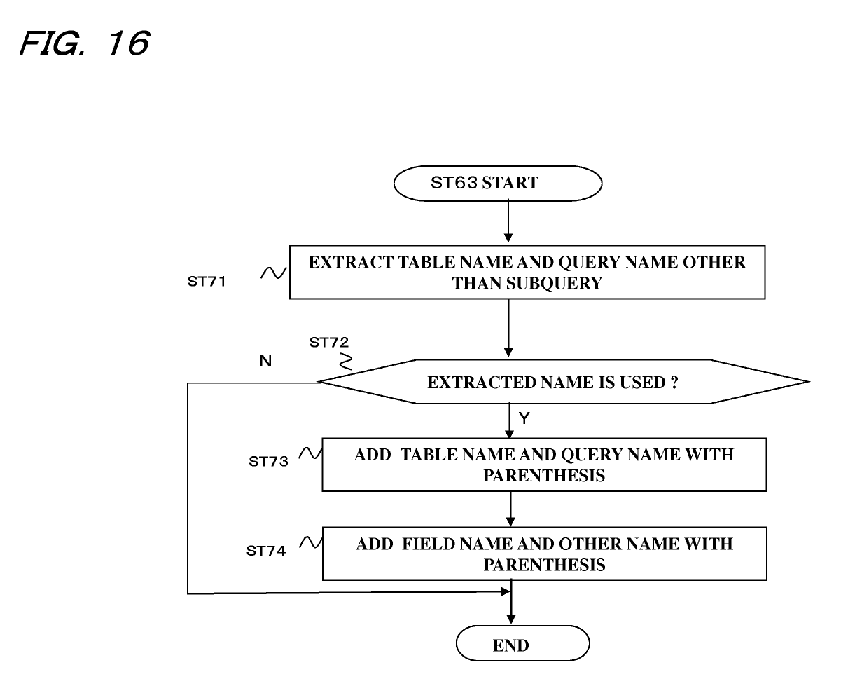

FIG. 16 is a flow chart for explaining the processing of step ST63 shown in FIG. 13.

Step ST71:

The parenthesis/combine unit 15 extracts query name data and table name data from the letter data except the subquery in each line in the second table data.

Step ST72:

The parenthesis/combine unit 15 judges whether the query name data and the table name data which are acquired in step ST71 are registered in management data prepared beforehand. And The parenthesis/combine unit 15 performs processing of step ST73 and ST74 only about a registered data.

The management data concerned are generated based on a program before the conversion automatically in “ACCESS”.

Step ST73:

The parenthesis/combine unit 15 inserts “[” in front of the query name data and the table name data which is judged it is registered in step ST72, and inserts “]” back of these data.

Step ST74:

The parenthesis/combine unit 15 inserts “[” in front of the field data and another name data, and inserts “]” back of these data.

In addition, query management data in which the query name data and addresses of the firs and second table data of the query in the memory is defined. The processing for adding the parenthesis mentioned above may be performed for the query name data in the query management data.

[Step ST4]

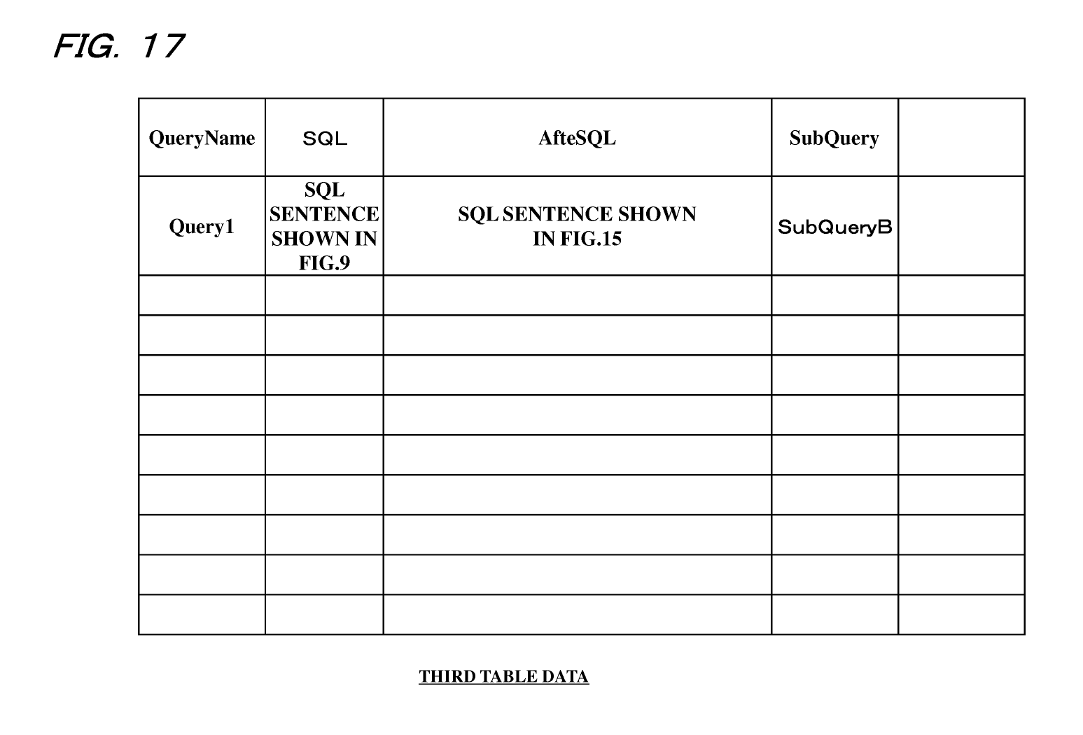

FIG. 17 is a figure for explaining an example of the third table data.

The third table data have the item of a query name (QueryName), SQL (an SQL sentence of the query shown in FIG. 9), SQL after the conversion (an SQL sentence shown in FIG. 15) and the subquery name (SubQuery) as shown in FIG. 17.

In SQL Server, the processing of SQL sentence is possible using the third table data shown in FIG. 17.

According the data conversion apparatus 1, the first (the second) table data shown in FIG. 10 are generated for the query in the ACCESS program using conversion list data shown in FIG. 7 and FIG. 8.

Then conversion process is performs based on these table data.

It is enabled to treat the conversion front query of various kinds as the common table data which satisfies the constant rule by generating such first table data in an intergrade and can raise conversion efficiency.

In the present embodiment the parenthesis that is an identifier distinguished as a name in SQL Server is added to the table name data, the query name data, the field name data and the another name data of the conversion front query as shown in FIG. 13 to FIG. 16, etc.

Therefore even if there is a part interpreted as a name to have a specific meaning in table name data, query name data, the field name data and the another name data which are decided freely by a user in SQL Server, it is possible to make the name to be interpreted in SQL Server as the name which is intended at the time of being programmed in ACCESS. Hereby it is possible to avoid miss operation.

Further, in the present embodiment, each line of the first and the second table data shown in FIG. 10 is read and combined by order decided based on combination pattern data defined based on the kind of the conversion front query to generate the converted query.

About a plurality of the conversion front query, it is possible to cope with the conversion processing of a various conversion front query only by generating the first table data using the same algorithm and using an unique combination pattern data. Hereby it is possible to lower a burden with the systems construction.

Further, in the present embodiment, as shown in FIG. 4, the first table data of the subquery is automatically generated, and the processing shown in FIG. 13 and FIG. 16 are performed the same with normal query. Therefore it is possible to convert the subquery properly.

Further, in the present embodiment, it is judged whether it is registered in table data indicating a query which is generated automatically by “ACCESS” as shown in FIG. 16, and a processing to bind with a parenthesis is performed only when it is judged that it is registered. Therefore error occurs in the processing of the SQL Server about the name that is not registered officially and bug will be discovered.

It is possible to define a continuous processing comprising inspecting whether or not the name of the table name data and the query name data are registered officially and binding with parenthesis by performing the processing of binding the field name data and phase name data with parenthesis (ST74) earlier than the processing of binding the table name data and the query name data with parenthesis (ST75).

The data conversion apparatus 1 shown in FIG. 3 mentioned above is realized by the hardware shown in FIG. 14, for example.

As shown in FIG. 14, the data conversion apparatus 1 has an interface 21, a display 22, operation unit 23, a memory 24, and a processing circuit 25, for example, and these are connected via bus 20.

The interface 21 is used, for example in order to communicate with other computers.

The display 22 displays various screens according to the signal from the processing circuit which executes the program PRG.

The operation unit 23 is operation means, such as a keyboard and a mouse.

The memory 24 memorizes the program PRG and the temporarily data used for processing of the program PRG. In addition, the program PRG may be memorized by an optical disc, a magnetic disk, the semiconductor memory device, etc. and may be read to a memory 24.

The processing circuit 25 performs the program PRG and controls processing of the data conversion apparatus 1. In each processing indicated by the flow chart of this embodiment, the processing circuit 25 writes the data in processing process in a memory 24 one by one, and reads it.

Processing of the data conversion apparatus 1 shown with this embodiment is described by the program PRG.

This invention is not limited in the embodiment mentioned above. Namely, regarding the component in the embodiment mentioned above, a person skilled in the art can do various changes, combination, sub-combination and substitution in the technical or equivalent scope of this invention.

For example, in the embodiment mentioned above, the example in which the related database system to be converted is “ACCESS” of Microsoft Corp., and the database system of after conversion is “SQL Server” of Microsoft Corp. is explained.

It may apply other database system having the function described in claims.

Further in the present embodiment described above, the case in which parenthesis “[ ]” is added to the table name data, query name data, field name data and phrase name data is explained step ST73, S74 as shown in FIG. 16. In the present invention, another identifiers may be added if these are interpreted as a table name, query name, field name and phrase name in the second database system.

1. A data conversion method for converting a first program including a plurality of first queries predetermined in a first database system into a second program including a plurality of second queries which may be processed by a second database, comprising;
generating a first table data including a query type data of the first query, a table name data included in a character string of the query and a plurality of lines storing a field name data and phase name data individually;
generating a second table data which converts data in the line in the first table data into expression determined in the second database system based on a predetermined conversion table;
reading combination pattern data corresponded for the query classification data beforehand from a memory based on the query classification data in the second table data, reading the data in the a line of the second table data sequentially based on the order indicated in the combination pattern data;
adding an indication indicating a name to be indicated by the second data base with the table name data and the field name data of the read data and storing a result of the adding to a predetermined variable; and
storing the data stored in the variable a item of the post conversion query in the line corresponding to the query of the first query in the third table data used in the second database system of the second after completion of storing of data of last line of the second table data predetermined by the combination pattern data to the variable.

2. A data conversion method as set forth in claim 1 further comprising:
generating the first table data with respect to the subquery in the case the subquery exists in the first query, and
wherein
processing of the generating the second table data, the reading, the adding the indication and the storing the data are carried out sequentially from the query of the bottom layer, and processing to return the processing result about the subquery to the line corresponding to the second table data of the upper query thereof is performed.

3. A data conversion method as set forth in claim 1 wherein
the generating the first table comprises
tracing a character string in the first query, and generating the first table data comprising the line which stored attribute data indicating start position of the character string position of the first query, the line which stored the attribute data indicating the query type data of the first query, the line which stored the attribute data indicating the table name or the query name of the first query and stored the table name data or the query name data, the line which stored the attribute data indicating the field name of the table of the table name and the field name data thereof, and the line which stored the attribute data indicating end position of the first query.

4. A data conversion method as set forth in claim 3 wherein
the processing of the adding comprises,
judging whether the subquery is included in the data which is read,
adding the identifier to the query name data and the table name data of the data other than the subquery to store the result to the variable.

5. A data conversion method as set forth in claim 3 wherein
the processing of the adding comprises,
judging the table name data is used officially in the first program by referring to the management data of the table name data which is official used in the first program and generated automatically by the first data base system with respect to the first program, and
adding the identifier to the table name data if it is judged it is used officially in the first program.

6. A data conversion method as set forth in claim 2 wherein
the processing of the adding comprises
adding the identifier to the query name data of the read data when query name data of the first query is stored in the line of the first table data.

7. A data conversion method as set forth in claim 2, wherein
a query management table indicating a query name data of the first query and address of the first table data in a memory is used,
the adding comprises adding the identifier to the query name data in the query management data.

8. A data conversion apparatus for converting a first program including a plurality of first queries predetermined in a first database system into a second program including a plurality of second queries which may be processed by a second database, comprising;
a first generator generating a first table data including a query type data of the first query, a table name data included in a character string of the query and a plurality of lines storing a field name data and phase name data individually;
a second generator generating a second table data which converts data in the line in the first table data into expression determined in the second database system based on a predetermined conversion table;
a reader reading combination pattern data corresponded for the query classification data beforehand from a memory based on the query classification data in the second table data, reading the data in the a line of the second table data sequentially based on the order indicated in the combination pattern data;
an adder adding an indication indicating a name to be indicated by the second data base with the table name data and the field name data of the read data and storing a result of the adding to a predetermined variable; and
a controller storing the data stored in the variable a item of the post conversion query in the line corresponding to the query of the first query in the third table data used in the second database system of the second after completion of storing of data of last line of the second table data predetermined by the combination pattern data to the variable.

9. A computer program tangibly embodied on a non-transitory computer readable storage medium which, when executed causes a computer to perform operation for converting a first program including a plurality of first queries predetermined in a first database system into a second program including a plurality of second queries which may be processed by a second database, the program comprises a description of processing to be executed by the computer, the processing comprises;
generating a first table data including a query type data of the first query, a table name data included in a character string of the query and a plurality of lines storing a field name data and phase name data individually;
generating a second table data which converts data in the line in the first table data into expression determined in the second database system based on a predetermined conversion table;
reading combination pattern data corresponded for the query classification data beforehand from a memory based on the query classification data in the second table data, reading the data in the a line of the second table data sequentially based on the order indicated in the combination pattern data;
adding an indication indicating a name to be indicated by the second data base with the table name data and the field name data of the read data and storing a result of the adding to a predetermined variable; and
storing the data stored in the variable a item of the post conversion query in the line corresponding to the query of the first query in the third table data used in the second database system of the second after completion of storing of data of last line of the second table data predetermined by the combination pattern data to the variable.
